(19) United States
(12) Patent Application Publication
(10) Pub. No.: US 2016/0247246 A1
(43) Pub. Date: Aug. 25, 2016

(54) PLAN VISUALIZATION

(71) Applicant: Sungard Availability Services, LP, Wayne, PA (US)

(72) Inventors: Derek Bluestone, Collegeville, PA (US); Laura Owusu-Antwi, Blue Bell, PA (US); Jason Prunty, Philadelphia, PA (US); Ronald Baumann-Erb, Phoenixville, PA (US); Scott LaFave, West Chester, PA (US); Kyle Gress, Exton, PA (US); Bhuvana Sundaresan, Exton, PA (US); Patrick Olivares, Malvern, PA (US); Francis Buck, Warminster, PA (US); Chris Trueblood, Wayne, PA (US)

(21) Appl. No.: 15/046,582

(22) Filed: Feb. 18, 2016

Related U.S. Application Data
(60) Provisional application No. 62/117,579, filed on Feb. 18, 2015.

(51) Int. Cl. G06Q 50/26; G06F 11/14; G06Q 10/06; G06F 17/30

(52) U.S. Cl. CPC G06Q 50/265; G06F 17/30312; G06F 11/1458; G06Q 10/06311; G06Q 10/0635; G06F 2201/84

(57) ABSTRACT

A Business Continuity Plan Visualization implementation for triggering a set of external technical processes to create event(s) that describes a disaster; specify Plan(s) relevant to the events and assets affected by the event; algorithmically assembling a logical, sequenced set of disaster recovery procedures and tasks based on the impacted location, business process or assets; assignment of these procedures and tasks to personnel and automated procedures responsible for executing them; managing real-time communications (text message, e-mail, push messaging, Text to Speech) delivered to personnel via other computers and smartphones at various locations; and reflecting status of all tasks or procedures as they are completed. The can also provide an in-context editable “view” of Business Continuity Plans specific to each incident responder.

### CROSS REFERENCE TO RELATED APPLICATIONS

This application claims the benefit of a co-pending U.S. Provisional Patent Application Ser. No. 62/117,579 filed on Feb. 18, 2015 entitled “PLAN VISUALIZATION” and is also related to a co-pending U.S. patent application Ser. No. 14/086,345 entitled “INCIDENT PLAYBOOK GENERATED IN REAL TIME FROM DISASTER RECOVERY PLAN EXTRACTIONS” filed on Nov. 21, 2013 and given Attorney Docket Number 111091-0031, each of which are incorporated by reference herein in their entirety.

### BACKGROUND

1. Technical Field

This patent application relates to a data processing system that provides an incident plan visualization environment. The system supports dynamic generation of tasks and procedures and real time dissemination of essential information to incident responders.

2. Background Information

Enterprise risk management is an increasingly critical consideration in any business. Catastrophic events such as hurricanes and earthquakes have shown that any organization is exposed to potentially catastrophic loss. The ability to swiftly recover critical business processes and information technology infrastructure during such crises is essential to mitigating economic loss. It is therefore now common for most any enterprise of significant size to develop plans to deal with various types of crises. These plans can include Business Continuity (BC), Disaster Recovery (DR), Crisis Management (CM), Emergency Response (ER) and other plans. Any given business may have multiple such plans, depending on the businesses in which it engages, different plans for different operations and departments, different plans for the different types of physical facilities it operates, for different physical locations, and so forth. These risk management solutions typically rely on outputs that generally take the form of one or more printed or digital version of a plan document. The plan documents are intended to be distributed as action guidelines for members of recovery team. This static content is therefore only constructed during pre-planning stages and not during an emergency as it contains much information that is not pertinent to what individual members of the recovery team actually need to know to carry out the action plan.

Additionally, if more than one plan needs to be consulted and activated, recovery team members are faced with having to review all of the plans in their entirety. Plans are needed for recovery of business processes, such as human-implemented department functions. But other plans impact assets such as a data processing systems that are amenable to automated recover processes. These disparate action plans become far too complex to be undertaken in a coordinated fashion in a crisis. Indeed, our informal polling has shown that at the time of a crisis, approximately 70% of recovery teams members do not use the plans at all, believing them to be too complex.

Consider a situation where an impending hurricane is forecast for the businesses operation. An incident planner and/or other administrative personnel at a business begins to become alarmed when they see or hear a local weather report. The planner will have to now consider a series of plans. The enterprise may have a detailed business continuity plan. The BC plan details and how to keep the retail aspects of the business open during bad weather. But the planner must also consider an Information Technology (IT) disaster recovery plan that details a set of automated procedures for how to, for example, enable a backup data center located at a remote site to start replicating data. The administrator might also have to consider a crisis management plan that spells out policies and procedures for communicating with first responders, medical personnel, members of the press, and so forth.

The situation is further complicated by the fact that a business with a presence in more than one location typically needs a set of crisis plans device for its facilities in different cities. An office located in the city of Philadelphia, Pa. which also has IT systems, may have similar but not exactly the same procedures as a satellite office in New York City for IT disaster recovery.

In all of these situations the administrator and/or upper management of the enterprise are primarily concerned with operational resilience. To achieve the best possible result, disaster recovery teams should know exactly what do at the time of disaster, to minimize downtime, and bring the business back up as quickly as possible. Within a typical enterprise, configuration information for these settings is spread across multiple documents. Recovery procedures are also quite susceptible to frequent changes, which are difficult to transmit among responsible emergency personnel.

### SUMMARY

A system and method called Plan Visualization herein affords the ability to access plans across these systems, processes, and devices and renders them in meaningful ways so that users can quickly access what is needed from their plans.

In one implementation, Plan Visualization provides a method for triggering a set of external technical processes to:

create event(s) that describes a disaster;

specify Plan(s) relevant to the events and assets affected by the event, the Plan(s) specifying task(s), sub-task(s), procedures as well as any ancillary information necessary to invoke them such as Locations, Personnel, Business Processes;

automatically generate a sequenced list of disaster recovery procedures based on:
algorithmically assembling a logical, sequenced set of disaster recovery procedures and tasks based on the impacted location, business process or assets
assignment of these procedures and tasks to personnel and automated procedures responsible for executing them;

manage real-time communications (text message, e-mail, push messaging, Text to Speech) delivered to personnel via other computers and smartphones at various locations;

maintain Geographic Information Systems (GIS) information describing the impacted resources (buildings, business processes, people, vendors, customers and other meta-data) on a digital map and making that accessible to responding personnel;

while maintaining a dynamic, interactive flow diagram demonstrating the inter-dependencies between assets that need to be recovered and with lists of process tasks and procedures resulting in the updating of status and completion of said tasks/procedures (including both automated tasks and those to be completed by recovery personnel), reflecting status of all tasks or procedures as they are completed.

In some implementations, Plan Visualization presents a remote, in-context, editable “view” of Business Continuity Plans including the tasks and procedures specific to each persona. This “persona specific view”, generated by leveraging the power of a relational database, is dynamically rendered and provides real time awareness to plan changes enterprise wide.

For a consumer, it is important that they quickly access tasks needed to ensure their safety so they can achieve the goals of recovery. For planners and administrators, who require additional information in order to make decisions, Plan Visualization offers additional features such as plan maintenance and approvals, ensuring plans are relevant.

With Plan Visualization, if a business disruption occurs, uses can be confident that all plans are up to date. If real time changes are needed during an incident, Plan Visualization enables this information to be disseminated real time to all users.

No current software tool offers organizations a visualization of their Business Continuity Plans within the product, where users can clearly view what is critical for a recovery of their business. Other solutions do not present an in-context and editable view, which is relevant to the goal of the user. For example, most services only offer Portable Document Format (PDF) versions of the plan to inform their planners; these fixed plans and critical information contained therein can then quickly become outdated and irrelevant.

Because organizations are reliant on mobility during the time of an event, it is crucial that plans are available on various form factors and device types. Plan Visualization affords the ability to access plans across these devices and renders them in meaningful ways so that users can quickly access what is needed from their plans.

Plan Visualization helps customers of a Business Continuity service maintain their business continuity plans for the lifetime of the customer's program, which has no end date. While many customers are regulated to have a Business Continuity Plan, more and more companies are seeing the value and the need to have a Business Continuity Program in place. Since plans are a living entity, with changes happening every day, such as employee or location information and changing business priorities, Plan Visualization will enable customers to have confidence in their plans.

The methods for the display of quantitative information are a result of unique aspects and include dynamically driven workflows, advanced charting capabilities, in-context maintenance features and real time indicators of plan health within the Plan Life-cycle.

### BRIEF DESCRIPTION OF THE DRAWINGS

The invention description below refers to the accompanying drawings, of which:

FIG. 1 is a high level diagram for a Plan Visualization system;

FIG. 2 is an architecture diagram for the system implemented on an AssuranceCM platform;

FIG. 3 is a high level workflow for Plan Visualization;

FIG. 4 illustrates Plan Visualization interaction with incident responders;

FIG. 5 shows interfaces to an automated recovery service;

FIG. 6 shows more detail of automated recovery;

FIG. 7 is an example screen where a user can specify an object in a data dictionary such as an event object;

FIG. 8 is a screen shot showing a location object;

FIGS. 9A and 9B illustrate an example of how a user may associate applications and dependencies;

FIG. 10 is an example Incident Management Screen;

FIG. 11 is another example Incident Management Screen;

FIG. 12 is an example task progress detail screen;

FIGS. 13-16 are example smartphone screens showing responder-specific information; and

FIG. 17 is an example GIS screen.

### DETAILED DESCRIPTION OF AN ILLUSTRATIVE EMBODIMENT

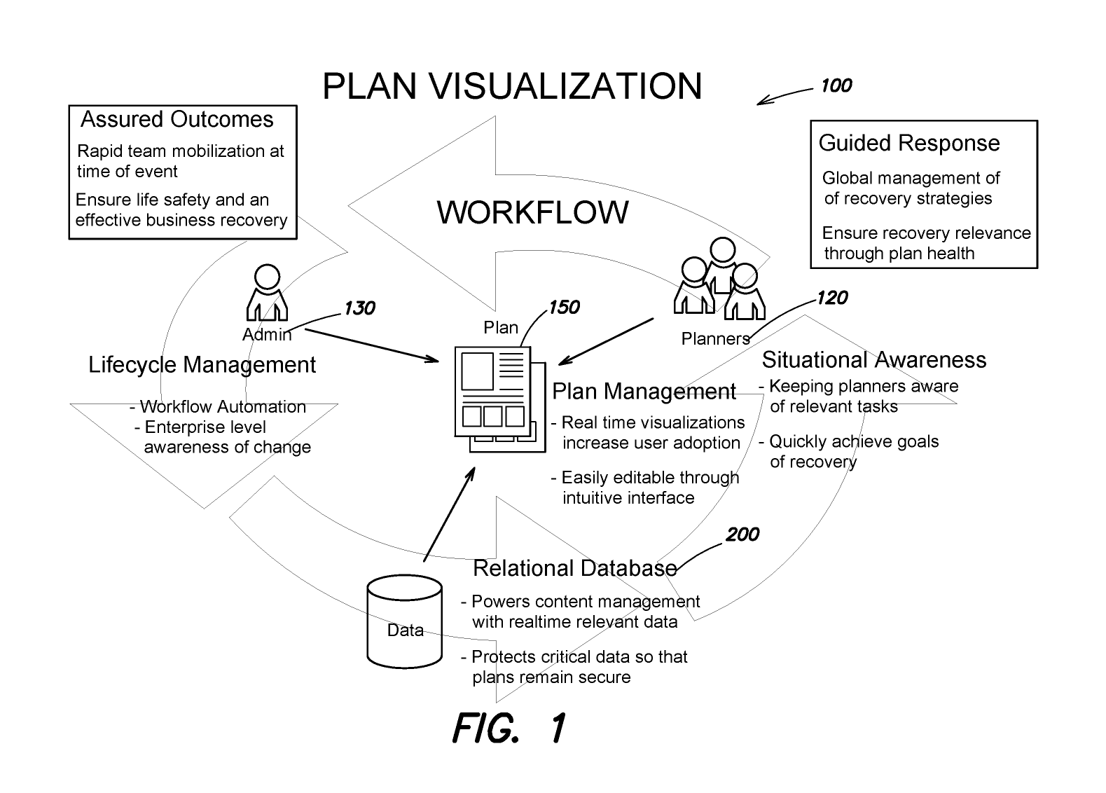

FIG. 1 is a high level process workflow diagram for a Plan Visualization 100 (also referred to as “PlanViz” herein) environment described herein. As can be seen, Planners 120 provide guided response inputs including global management of recovery strategies and ensure recovery relevance. Planners use Situational Awareness to stay aware of relevant tasks for one or more recovery plans and achieve recovery goals. Planners are also provided with Plan Management features such as real-time visualizations that are easily editable through an intuitive user interface. Administrative users 130 provide workflow automation and an enterprise-level awareness of change. Assured Outcomes include rapid mobilization at the Time of Event, ensuring safety and effective recovery.

From a technical perspective, one preferred implementation of Plan Visualization 100 is built on top of a suite of reusable frameworks within a Relational Database Management System 200. One such environment may be provided within the Assurance Continuity Management (AssuranceCM) Software-as-a-Service offering from SunGard Availability Services of Wayne, Pa. Here we will introduce those frameworks as one example implementation of Plan Visualization 100, although it should be understood that other implementations are possible.

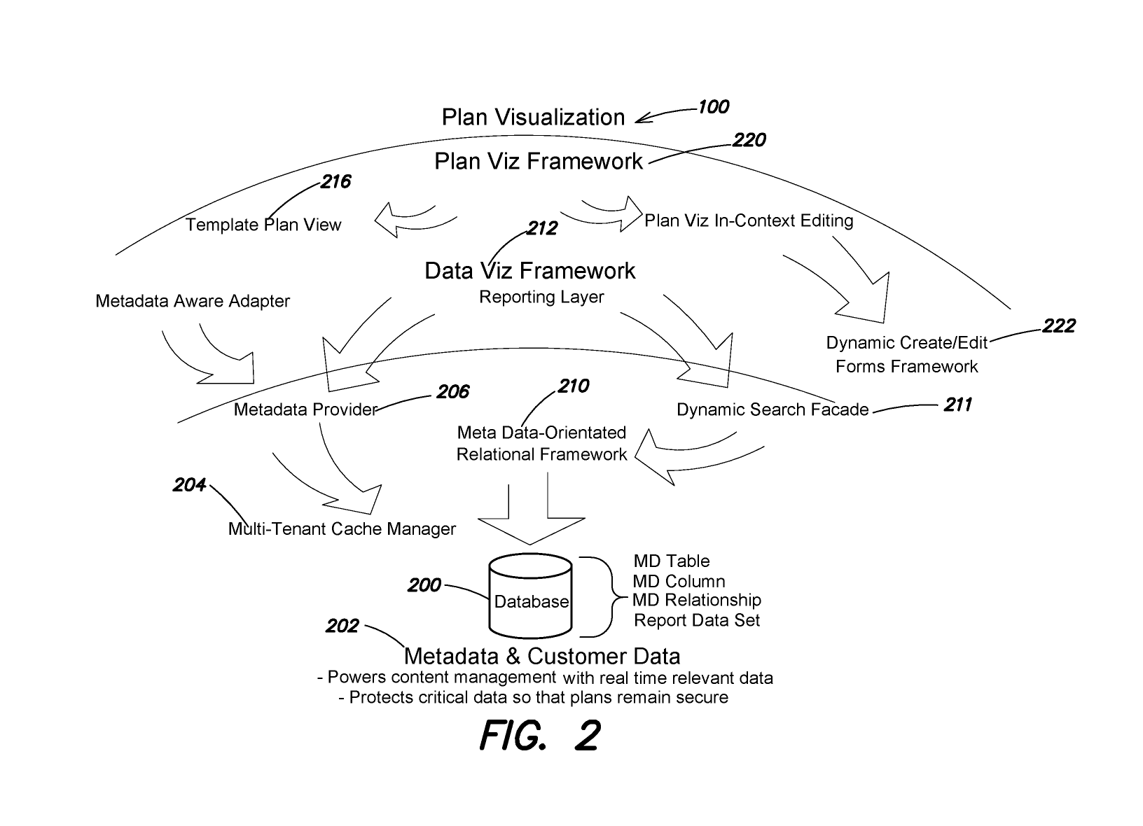

Reference to the high level Technical Architecture diagram of these parts in FIG. 2 will assist with the following further discussion.

Plan Visualization Technical Architecture

A Plan Visualization feature may be built on top of a suite of reusable frameworks within the Assurance CM Software-as-a-Service offering from SunGard Availability Services of Wayne, Pa. This document introduces each of those frameworks from the bottom up. A further technical discussion is found later in this document, but it can be best understood as a composite of the connected and yet discrete parts. A high level diagram of these parts is below.

Metadata & Customer Data 202

The system is, to a great extent, a metadata-driven system. This means that all customer database entities are fully described in a set of objects and metadata stored in a relational database 200.

Metadata of Customer Data 202 includes a “Metadata Table” table (MDTable) that contains rows that describe customer tables. Every customer table, therefor, has one row in MDTable. Likewise, there is a “Metadata Column” table (MDColumn) that contains rows that describe customer columns. Additionally, there is a “Metadata Relationship” table (MDRelationship) that describes how customer tables are related. Another construct is the ‘ReportDataSet’, which is comprised of a base table and a series of relationships. Also contained in the metadata 202 is a description of database views and the source tables/columns that each view column refers to. There may be more metadata information than this included, as described in more detail below. The central idea is that by consulting the metadata, data describing Plan Visualization can be processed in a dynamic way to automatically develop action plans.

Multi-Tenant Cache Manager 204

The Multi-Tenant Cache Manager may use the C# “generics” mechanism to handle the loading, caching and retrieving of cached objects. Each request for a cached object uses two components to construct the cache key. One component is the object type (a Metadatalnfo class, for example, may have a “type” that evaluates to its fully qualified namespace and class name). The second component is the customer name for the authenticated user. As such, requests for cached objects of the same type made by different users who are logged in to the same customer database will get the same cached object. However, requests for cached objects coming from two users who are logged in to different customer databases will produce different cache keys and so will return different cached objects.

The Multi-Tenant Cache Manager may use generics for the cacheable classes and an interface mechanism for “loader” classes. The Multi-Tenant Cache Manager, therefore, is completely unaware of what it is caching and of how it is loaded. When constructed, it is given a class type and a loader that implements an ICacheLoader<T> interface. When the manager is retrieving an object from cache and it detects that the object does not exist in cache, it uses the “loader” object it has been given to create and hydrate the object, puts that object into cache and then returns it.

Metadata Provider 206

At runtime, the information in the metadata tables is read and loaded into a fully hydrated C# class structure and the resulting object is placed in cache. The ‘Metadata Provider’ object is used to provide this information to application code. The Metadata Provider leverages the Multi-Tenant Cache Manager for fast retrieval of cached metadata information.

Metadata-Oriented Relational Framework (Morf) 210

This component includes a CodeGen Utility, Fluent Interfaces, Metadata Adapter, and Dynamic Search Façade.

CodeGen Utility

The CodeGen utility is used to generate concrete C# classes that represent database tables, views and stored procedures.

Fluent Interface for Static Database Operations

Morf 210 provides a C# fluent interface for developing code to perform database queries, updates, inserts and deletes by reference to the concrete classes generated with the CodeGen utility. For queries without joins, Morf returns objects of the concrete type for the requested table or view. For queries with joins, Morf returns generic DataRecord objects.

Fluent Interface for Dynamic Database Operations

Morf 210 provides a C# fluent interface for developing code to perform database queries, updates, inserts and deletes without reference to the concrete classes generated with the CodeGen utility. This is where the Metadata Provider is needed. Given an entity name or a metadata table ID, the Metadata Provider returns a C# object of type MetadataTable that represents that table or view. A MetadataTable object contains a lot of subordinate data, including a collection of objects of type MetadataColumn, which represents a column on a table or view. Similarly, given a table-column name or a metadata column ID, the Metadata Provider returns a C# object of type MetadataColumn that represents a column on a table or view.

The objects returned by the Metadata Provider can be used with the Morf fluent interface to perform database operations. For all dynamic queries with or without joins, Morf returns generic DataRecord objects.

Metadata-Aware Adapter

Morf 210 allows application code to inject an “adapter” object that can be implemented to adapt queries, updates, inserts and deletes as needed. Assurance injects an adapter object that is metadata-aware. The Assurance adapter object uses the Metadata Provider to adapt queries to include joins that will fetch additional data from related tables. Values from those related tables are pulled into the results set and are available as additional “selected” columns (these are called “lookup” columns).

Dynamic Search Façade 211

The Dynamic Search Facade is a single C# class that facilitates and simplifies dynamic searches. It allows application code to pass in objects that represent the elements of a query (selected columns, joins, sort columns, filters etc.). It then interacts with Morf, initiates the query and then returns a complex object that includes the results set. The Dynamic Search Facade is designed for reuse.

DataViz Framework 212

DataViz is a framework that enables metadata-oriented reporting, and includes DataViz Reporting Data Sets, Report Builder, Engine and Renderer.

DataViz Reporting Data Sets

An Assurance CM “Data Set” is a predefined sequence of tables and views, where there is a metadata-defined relationship between each “step” in the sequence. To an Assurance CM user, a Data Set is a named reporting template that establishes the fields that can be included in a report. To an engineer, a Data Set is also a construct from which a series of joins can be dynamically constructed.

DataViz Report Builder

The DataViz Builder is a user interface framework that allows a user to graphically build a report by selecting columns, specifying filter conditions, choosing a layout and so on. The resulting report definition is saved in the database as a named report. The first step in the builder involves choosing a Reporting Data Set.

DataViz Engine

The DataViz Engine executes a report definition by using the Metadata Provider 206 to construct query elements (selected columns, joins, filters etc.) and then passing them to a Dynamic Search Façade 211 object. The engine returns a rich results set that includes details about the tables used in the report. Where views are used to generate the report, the engine returns information about the source tables that the view columns refer to. The primary key values of the rows in the results set are also included in the rich results set.

The DataViz Engine may employ a Request/Response pattern for running reports, in part because it returns requested “blocks” at a time. The consumer of the engine specifies block numbers that it wishes to receive. It would be reasonable and expected (although not required) that the first request for a given instance of a report results set would contain block numbers one through n (1-4, for example). When the engine receives such a request, it executes the report, assembles the rich results set, puts the results set in cache and returns the requested blocks of results along with the cache key in the response. The consumer can then receive the next sequence of blocks by including the cache key in a subsequent request (and by specifying the next block numbers, such as 5-8). For such a request, the engine uses the cache key to retrieve the results set from cache and then it returns the requested blocks.

DataViz Renderer

The DataViz renderer may be implemented using a view engine such as Model View Controller (MVC) Razor, JQuery and/or Ajax. The initial rendering of a report involves invoking an MVC controller endpoint to get the first set of rich results set blocks. That endpoint returns an MVC view that runs the Razor code to render those blocks. The JQuery code handles events that enable “infinite scrolling”, wherein subsequent requests are sent via Ajax as needed as the user scrolls to the end of the previously rendered blocks.

Template Plan View 216

A Plan is typically based on a Plan Template. Administrators or planers create many plan templates that they then use as templates to create many plans. A Template Plan View 216 is part of what makes up a Plan Template and is, in effect, comprised of a series of reports (built using the DataViz framework) and documents (PDFs that have been loaded into the system either as PDFs or as documents in other formats that get converted to PDFs).

At the database level, a Template Plan View 216 is comprised of rows in a many-to-many table between the Plan Template table and the Report and Document tables.

PlanViz Framework 220

When a user lands on a plan, she sees a “visualization” of that plan, which is comprised of the reports and documents listed in the Plan Template for the plan, along with additional documents that have been associated with the plan. This area of the product is called PlanViz. When the user clicks on one of the documents, the PlanViz code renders that document. When the user clicks on one of the reports, the PlanViz code invokes the DataViz framework 212 to render the report.

Dynamic Create/Edit Forms Framework 222

In Assurance CM, forms that are used for creating and editing records in customer tables are generated and processed generically. The structure of those forms is defined in the database. Generally, given a table name and a primary key value, Assurance CM can dynamically construct and process an edit form on which a user can make changes to the record specified by the primary key. When the primary key value is not provided, then the form behaves as a “create form”.

PlanViz in-Context Editing

PlanViz allows users to make changes to the data that is shown in the rendered reports. Because PlanViz leverages DataViz, there is a wealth of information available in the rendered report, including the referenced source tables and the primary key values for the records in the report. When a user clicks to edit values in a row, the PlanViz code is able to determine the source tables and the primary key values associated with those tables, and then by using this information, it is able to leverage the Dynamic Create/Edit Form Framework to allow the user to edit the various records represented in a single report row.

PlanViz 100 presents all of the relevant editing forms in a slider. It uses JQuery to allow the user to easily switch among the various forms. Because PlanViz leverages the Dynamic Create/Edit Form Framework 222, each form takes care of the security and validation rules that are already in place. As such, PlanViz is agnostic about such concerns. However, PlanViz takes over control of the initiation of the saving of the form data and the aggregation of the save status. Each form is still responsible for performing the save, but not the initiation of it. So PlanViz has a single save button; when that button is clicked, the PlanViz code iterates over the various forms and invokes the form's controller endpoint that handles the saving of that form's data.

Significantly, PlanViz also keeps track of the returned statuses and presents an aggregated status message to the user.

Plan Visualization Use Example

Plan Visualization 100 activation triggers a set of external technical processes that a) creates a sequenced list of disaster recovery procedures and tasks; b) assigns these sequenced tasks/procedures to the appropriate automated recovery systems and/or recovery personnel, and c) causes targeted message alerts (in the form of SMS, e-mail, push messaging, Text to Speech, et al.) to be delivered to incident responders via their computers and smartphones at various locations. The recipients of these messages use their separate computer or mobile smartphone application to process these tasks and procedures resulting in the updating of status. Status and completion of said tasks and/or procedures include both automated tasks and procedures to be completed as manual steps by recovery personnel. The status of these completed tasks or procedures is thus reflected back in the system.

Additionally, Geographic Information Systems (GIS) information may be computed describing the impacted resources (buildings, business processes, people, vendors, customers and other meta-data) on a digital map and sent to the recipients using another, separate computer or smartphone.

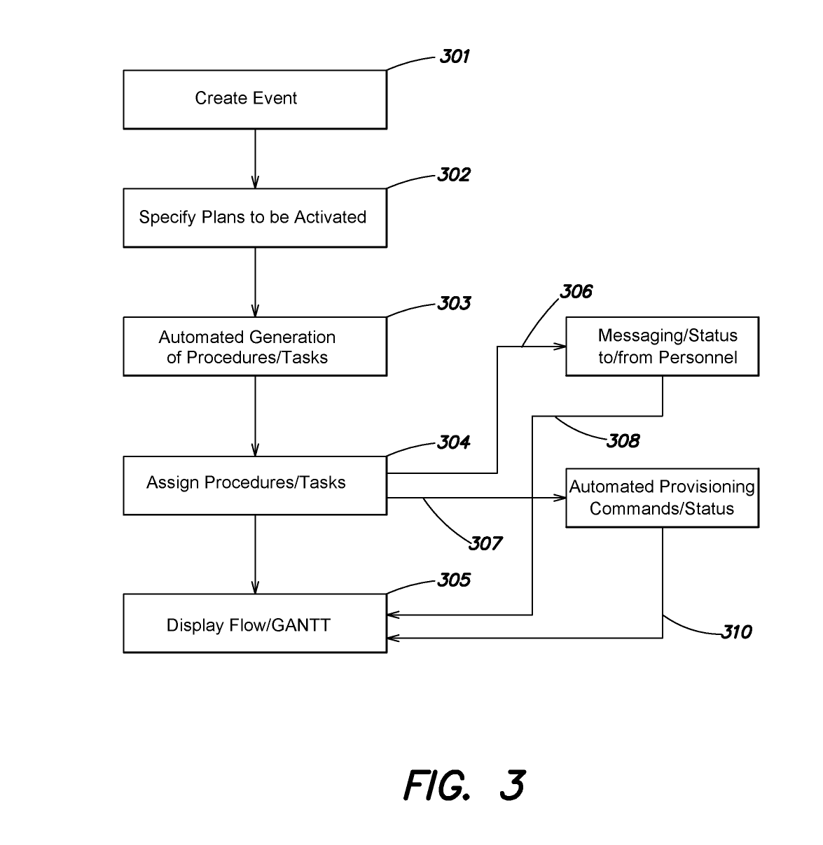

FIG. 3 is an example set of triggered steps for a sequenced list of disaster recovery procedures and tasks.

1. Step 301. The user creates an Event in the system that describes the disaster (ex. Hurricane, Flood, Active Shooter, Power Failure). This is an end user generated, manual step within the system.
2. Step 302. The user then specifies the Plan(s) that need to be activated in response to the Event as well as any ancillary information necessary to invoke the Plan(s) (such as Locations, Business Processes, Applications, etc.). This is an end user generated, manual step within the system.
3. Step 303: The system automatically generates the following

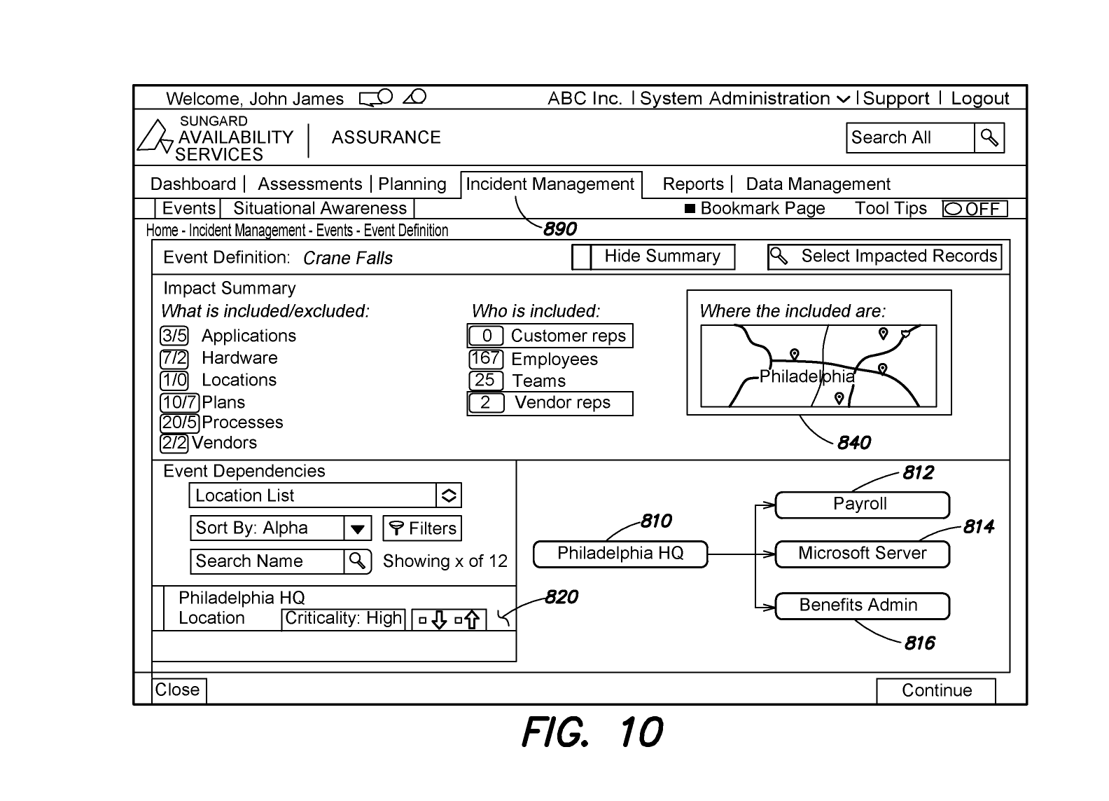

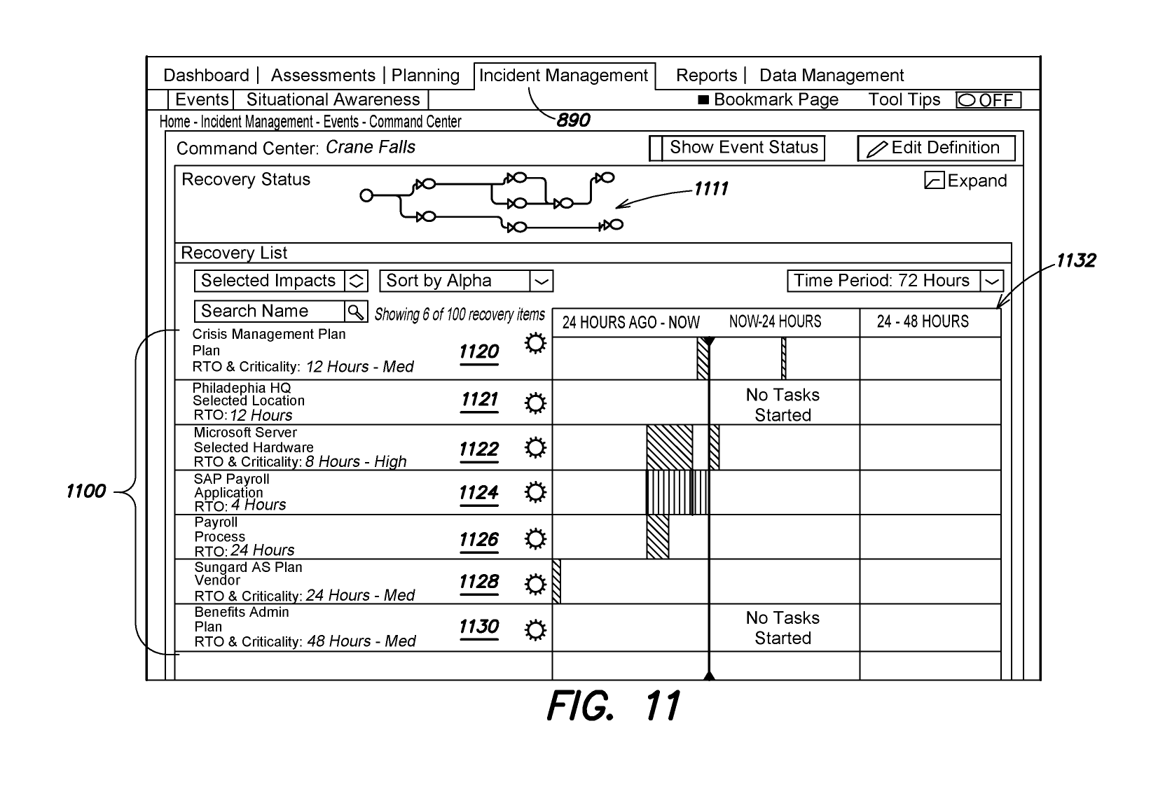

a. A sequenced list of disaster recovery procedures and tasks (see also FIGS. 10 and 11 discussed below). This sequenced list of disaster recovery procedures and tasks is generated based on:
Assembling and ordering data in the system initially inputted by manual plan building activities performed by users of the system. For example, a user may create a specific task, sub-task or procedure for recovery of a business process or application software in the system.
Algorithmically assembling the logical, sequenced set of disaster recovery procedures and tasks based on the impacted location, business process or asset. For example, the System may programmatically examine the data objects that represent impacted locations, business processes or assets and automatically determine which disaster recovery procedures and tasks are most relevant. The system may also determine an appropriate execution sequence for these, based on the cascading interrelationships that exist (for example, there may be 5 business processes that are impacted when Location A is down, each business process has a set of recovery tasks AND several of the business processes are dependent on one of the other business processes to be available so that they can be restored.

b. Step 304. Assignments of these procedures and tasks to personnel responsible for executing them
Assignments of procedures and tasks to personnel responsible for executing them in the system is a function of input by manual plan building activities performed by users of the system. For example, a user may assign a given task to a specific person.
Assignments of procedures and tasks to personnel responsible for executing them in the system is also a function of dynamic relationship creation between an assignee, their specific “role” profile as assigned by the Administrator of the system and their physical location or logical relationship with the the asset (Business Process, Location, Application etc.) that is being recovered.

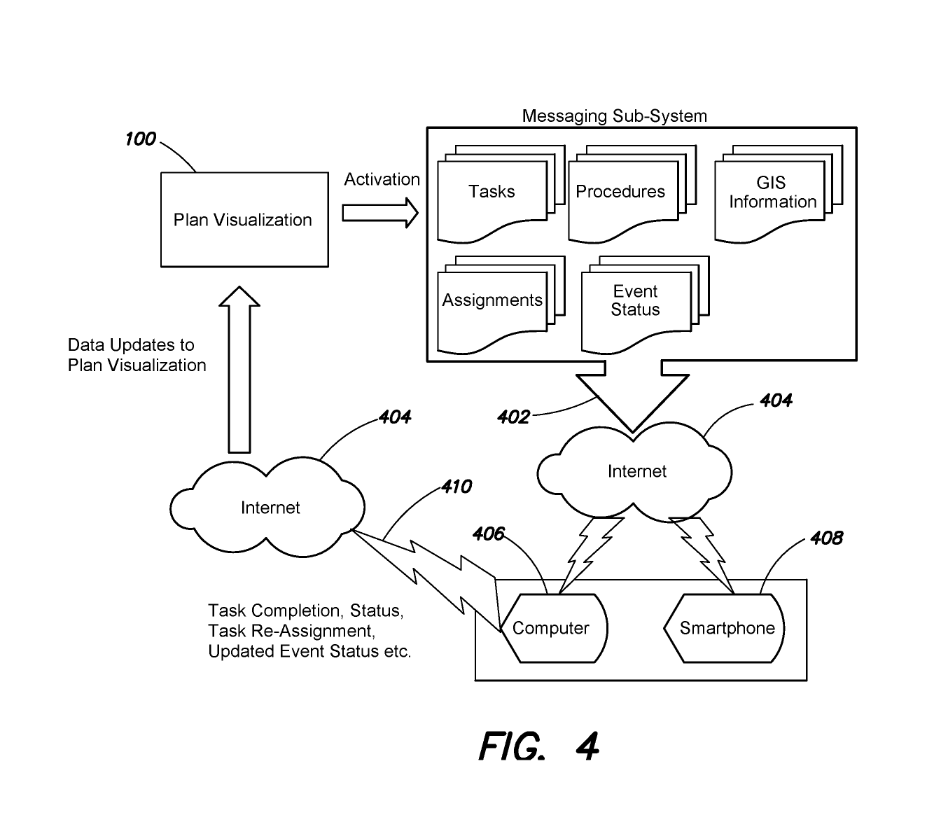

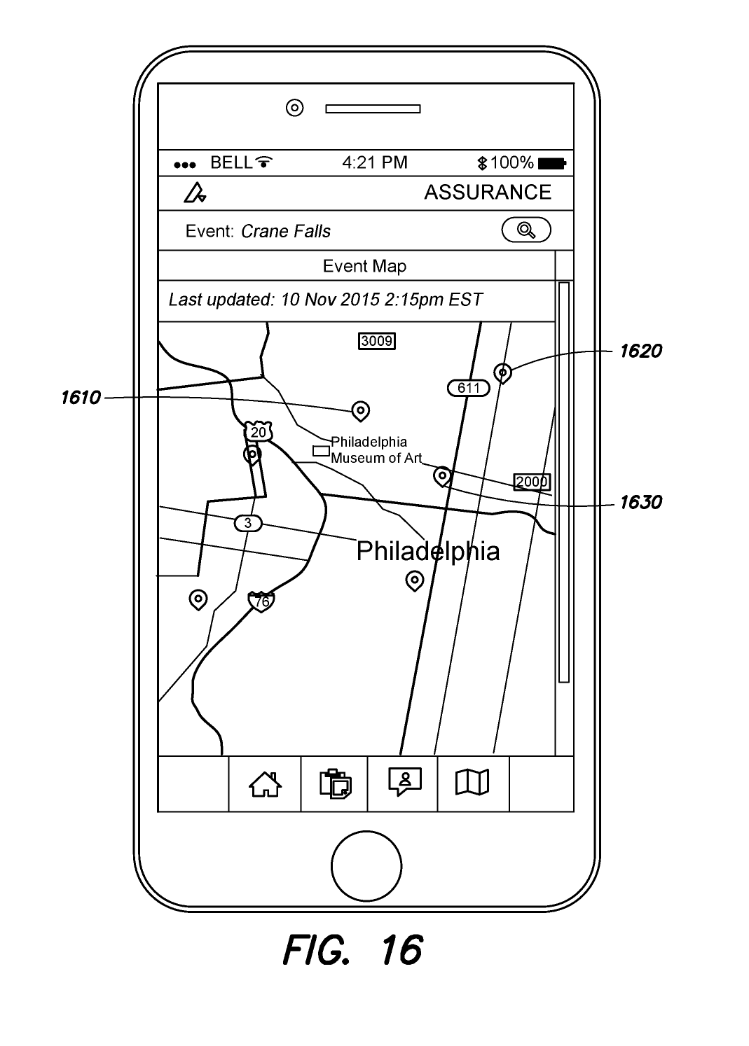

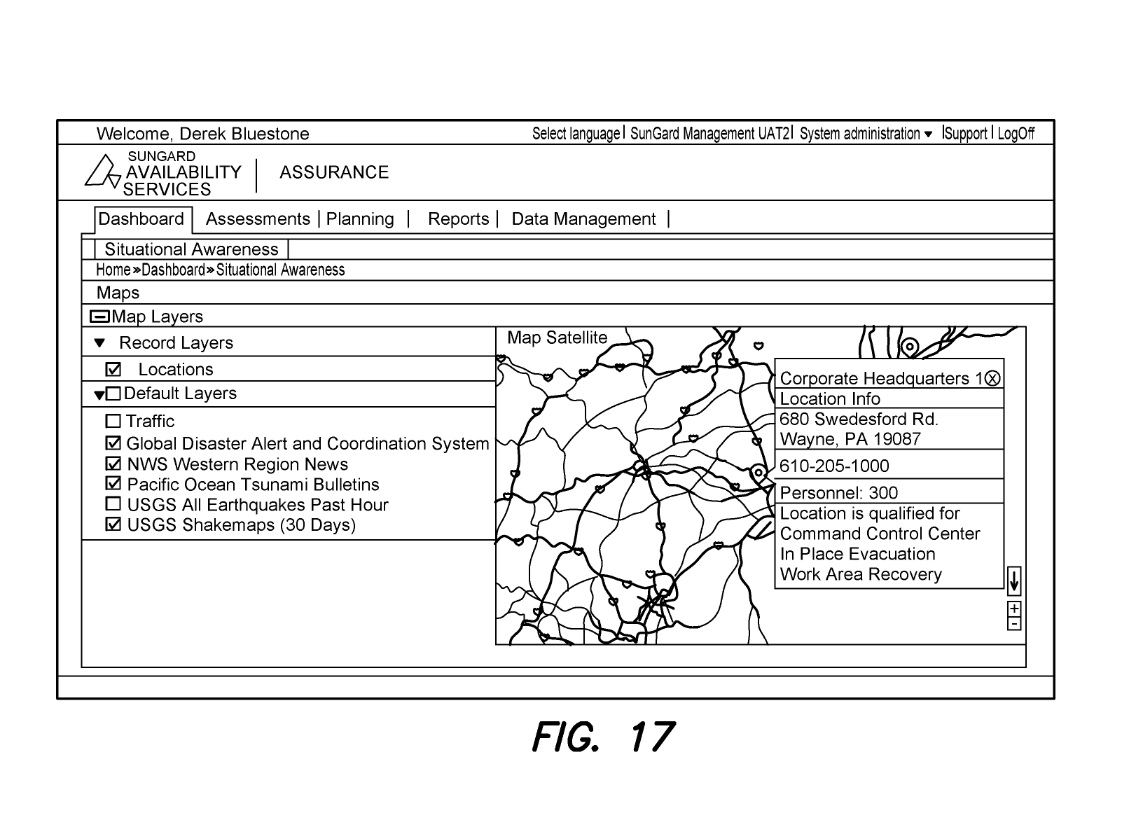

c. Step 305. A dynamic, interactive flow diagram demonstrating the inter-dependencies between assets that need to be recovered—for example all business processes that are dependent on a particular application or set of computer hardware (see FIGS. 10 and 11 for example views).
This is a system generated relational map or chart view that is created automatically by the system. The System reads the dependency relationships between assets (Locations, Business Processes, etc) and generates a contextual visualization in the form of an interactive diagram (See FIGS. 10 and 11 described in more detail below).
A GANTT chart view of the tasks and assignments indicating time-based sequencing of said tasks in a Digital Command Center view.
   4. Step 306. A dynamic messaging capability to effect real-time communications. This step assigns these sequenced tasks/procedures to the appropriate automated recovery systems, recovery personnel and causes targeted message alerts in the form of SMS, e-mail, push messaging, Text to Speech to be delivered to other computers and smartphones at various locations. Additionally, Geographic Information Systems information may be computed describing the impacted resources (buildings, business processes, people, vendors, customers and other meta-data) on a digital map and sent to the recipients using another, separate computer or smartphone.
The tasks and persons assigned thereto being generated as above, the system takes the recipient's (recovery personnel's) contact information (mobile application registration metadata and mobile phone number), assembles a data message containing the tasks, procedures, event description, GIS information (relevant to the particular recipient) and electronically sends this information via the Internet to the Mobile application or computer (see FIGS. 16 and 17 for example views).
Geographic Information System (“GIS”) information—the system may be integrated with a GIS such as Google Maps via the Google Maps API to automatically geocode Locations as “pin drops” on the Situational Awareness view. Additionally, the System allows additional meta-data “layers” to be added to the Map views. These meta-data layers include two types of data: a) data that has been inputted into the system via manual (ex. a user enters a Location street address in the system) or automated feeds (Human Resources Systems, IT Configuration Management Databases or “CMDBs” which contain specific, parameterized data about IT systems. CMDBs include detailed information which allow the System to capture the exact specifications and settings of applications, hardware, software and network which can be used to later specify the restoration of recovery environments in 3rd party private or public cloud environments later described in this document) and b) Keyhole Markup Language “KML” feeds from real-time third party data sources (ex. the US Geological Survey's Seismic Activity Feed or Traffic feeds). See FIGS. 4 and 17 for more information.
Having assembled this set of GIS data and meta-data in the System, the messaging sub-system (FIG. 4) automatic selects the appropriate subset of information, converts it into an Internet Protocol (IP) datagram or other suitable message format, and sends it to the smartphone or computers associated with the persons associated with those particular devices.
   5. Steps 308 and 310. The recipients of these messages use a separate computer or mobile, smartphone application to process these tasks and procedures resulting in return status messages that then permit updating of status and completion of said tasks/procedures in the system (including messages returned by both automated tasks (step 310) and those to be completed by recovery personnel (step 308)). The status of these completed tasks or procedures is reflected back in the system.

FIG. 4 illustrates this in more detail. Plan Visualization 100, upon activation of an event, uses Tasks, Procedures, Assignments, GIS Interaction and Status data to construct messages that are specific to each responder personnel. These are delivered over the Internet 404 to each individual computer 406 or smart phone 408 associated with a responding personnel. The personnel then interact with the application to update task status, inform the system of reassignment, etc., as the Plan is carried out. This update is sent via return messages over the Internet 404 back to Plan Visualization 100, stored as status updates, and reflected in the status display.

6. Step 307. In certain other example IT disaster response scenarios, Plan Visualization 100 activations triggers the automatic provisioning of other computer resources (virtual machines, operating system software, network and application software) in adequate quantity and configuration so as to be able to automatically recover the specified systems in Plan Visualization.

### Interface to Automated Provisioning Systems

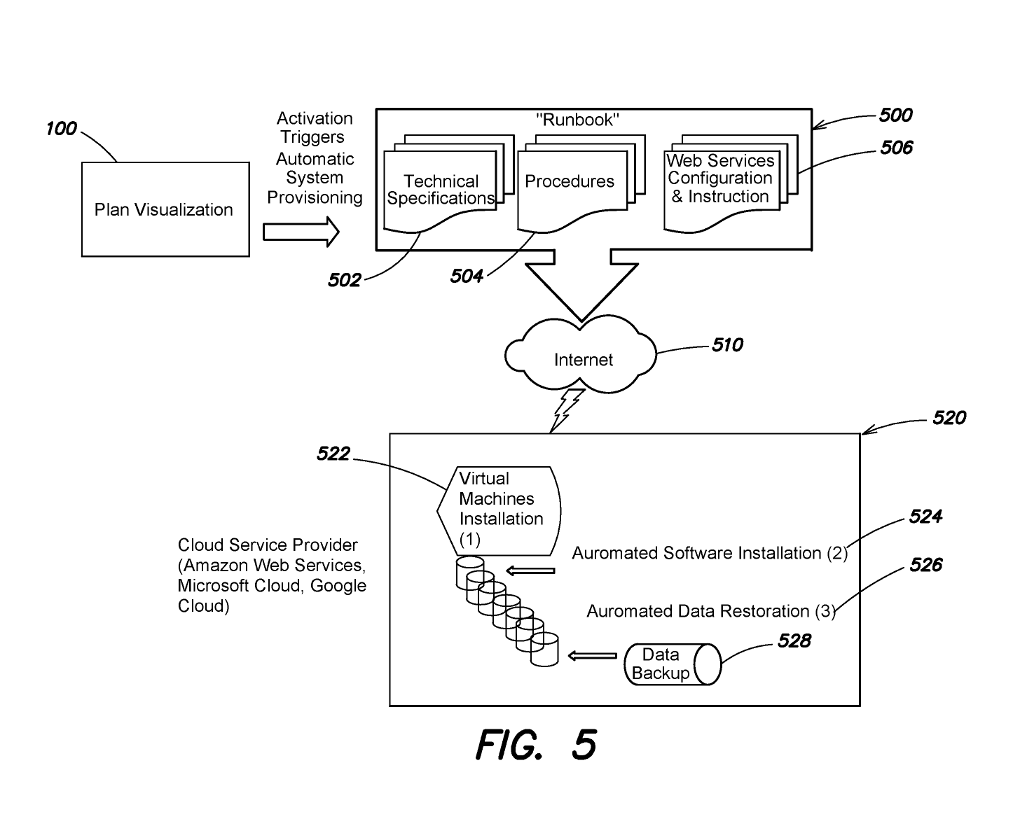

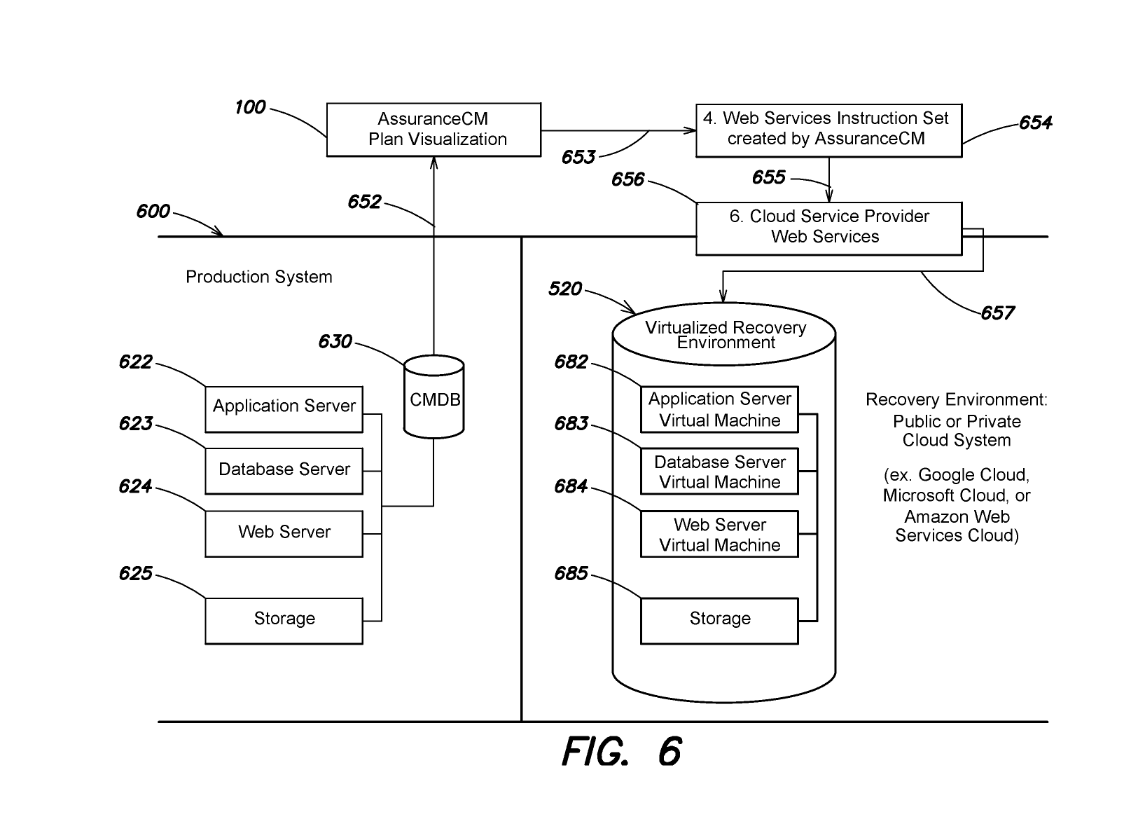

FIGS. 5 and 6 show in more detail how plan visualization 100 can interface with automatic provisioning systems to orchestrate installation and setup of assets affected by an event. For example, assets such as an application program running on a server may be automatically recovered using known orchestration tools based on information provided in a runbook 500. The runbook 500 specifies configuration of production system assets including software, hardware, network, memory, storage, virtual machines and so forth that can be instantiated in a remote public or private cloud environment. Such cloud environments may include those provided by public services such as Google Cloud, Amazon Web Services, or private clouds such as Microsoft Cloud or Hewlett-Packard Cloud. The runbook 500 may also include procedures to be executed to recover the asset as well as information concerning Web services configuration and instructions 506.

Runbook 500 information is then communicated over the Internet 510 to leverage these automated orchestration tools 520. Such automation tools may be specific to the cloud service used. Tools such as AWS Cloud Formation, or Google Container Engine, Microsoft Orchestrator, or other tools such as Hewlett-Packard Operations Orchestration may be used. These tools can be used to run automated procedures to install and set up servers and applications based on the runbook 500 technical specifications 502 and procedures 504. As a result, virtual machine installation 522, automated software installation 544, and automated data restoration 526 from a data backup 528 can be automatically triggered.

FIG. 6 shows one typical automated process where the recovery environment 520 may be a virtualized recovery environment as made available via public or private cloud systems such as Google Cloud, Amazon Web services, Microsoft Cloud or HP Private Cloud. The original production environment 600 may include one or more application servers 622, database servers 623, Web servers 624 and/or storage devices 625.

In an initial step 651, configuration information for these assets is gathered by a Configuration Management Database (CMDB) 630 maintained by the production environment 600. The information maintained in the CMDB may include detailed specifications for hardware, software, network storage and their corresponding settings and so forth. In a next step 652, the production system metadata and runbook configuration details as may be captured by the CMDB 630 are periodically shared with the Plan Visualization 100 (as may be implemented on the Assurance CM platform as described previously).

Upon the occurrence of a particular event in step 653, the user activates a recovery plan. In that step 653 Plan Visualization 100 will automatically generate a runbook from the available information in its database 200. At this point, in step 654, Web services instruction set is created by Plan Visualization 100 using information such as the Web services configuration and instructions 506. In step 655, a Web services interaction occurs with the public and/or private cloud provider that is hosting the virtualized recovery environment 520. This exchange may be through a services interface 656 or other Application Specific Interface (API) for the private/public cloud. In step 657, the cloud service instantiates the virtualized recovery environment 520 according to the instructions in the runbook. These instructions are thus executed to recover for example one or more application server virtual machine(s) 682, database server virtual machine(s) 683, Web server virtual machine(s) 684, and storage service(s) 685. More information about automated recovery procedures can be found in the patent applications referenced above.

### Example User Interfaces

We turn attention now to user interface aspects of Plan Visualization 100, and particular example interface screens for planners and incident responders to interact with the system 100.

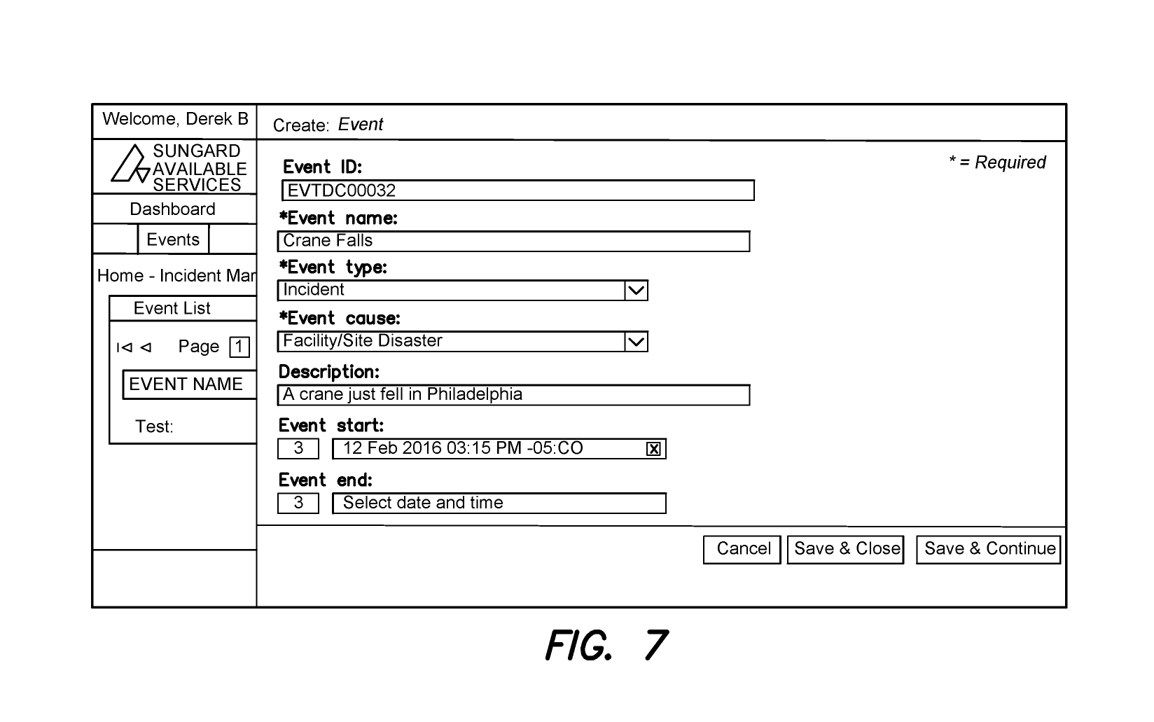

Referring now to FIG. 7, as explained previously, Plan Visualization 100 maintains a relational database 200 containing a number of data dictionary objects relevant to generation of the recovery plan. These relational objects may include information such events, locations impacted by such events, personnel expected to assist in the recovery, business processes including manual and or automated business processes needed to be recovered, and affected applications. The user defines in advance these objects relevant to recovery and metadata associated with these objects. The metadata and objects are defined with sufficient detail to enable Plan Visualization to automatically generate a logical sequenced list of recovery procedures including manual and automated procedures and tasks. Such metadata may at least include task dependencies which specify, for example, that a certain manual task or automated procedure must be completed before some other task may begin.

An event description may include information concerning impacted location(s), business process or assets affected by the event. In order to maintain geographic information systems relevant to the impacted resources, the metadata may also identify buildings, business processes, vendors, customers and other information needed for managing the real-time communications with the responding personnel. The types of the objects maintained in the data dictionary and metadata may concern software applications, hardware, locations, and processes. Further information such as the descriptions of affected assets, their attributes, affected customers, documents, other equipment, recovery strategies, suppliers, specific tasks and/or subtasks, teams associated with the recovery, telecommunication resources, vendors, vital records, workstations and other assets and/or descriptions thereof may be provided.

FIG. 7 should thus be considered a single example of a user interface enabling data entry into the data dictionary. Here, the user (a Planner or Administrator) is describing an event object. The event in question is a new emergency event which has just occurred, and which could not have been foreseen in advance. In particular, a construction crane has fallen unexpectedly on Broad Street in Philadelphia, Pa. adjacent to the enterprise's corporate headquarters. As can be seen, an event type, event cause, description, start and end time may be associated with the event.

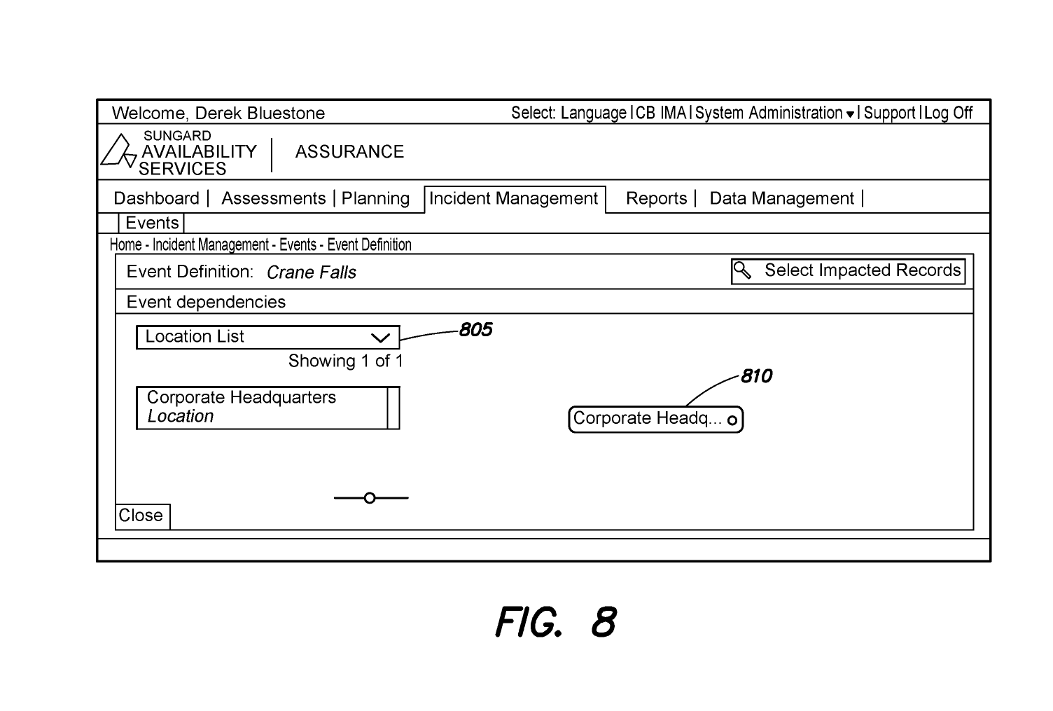

The user may also interact with an incident management screen such as that shown in FIG. 8 where an affected location is associated with the event. Here corporate headquarters location is associated with the event now called “Crane Falls”, and the affected location is depicted in an area of the screen 810 with a block labeled “Corporate Headquarters”.

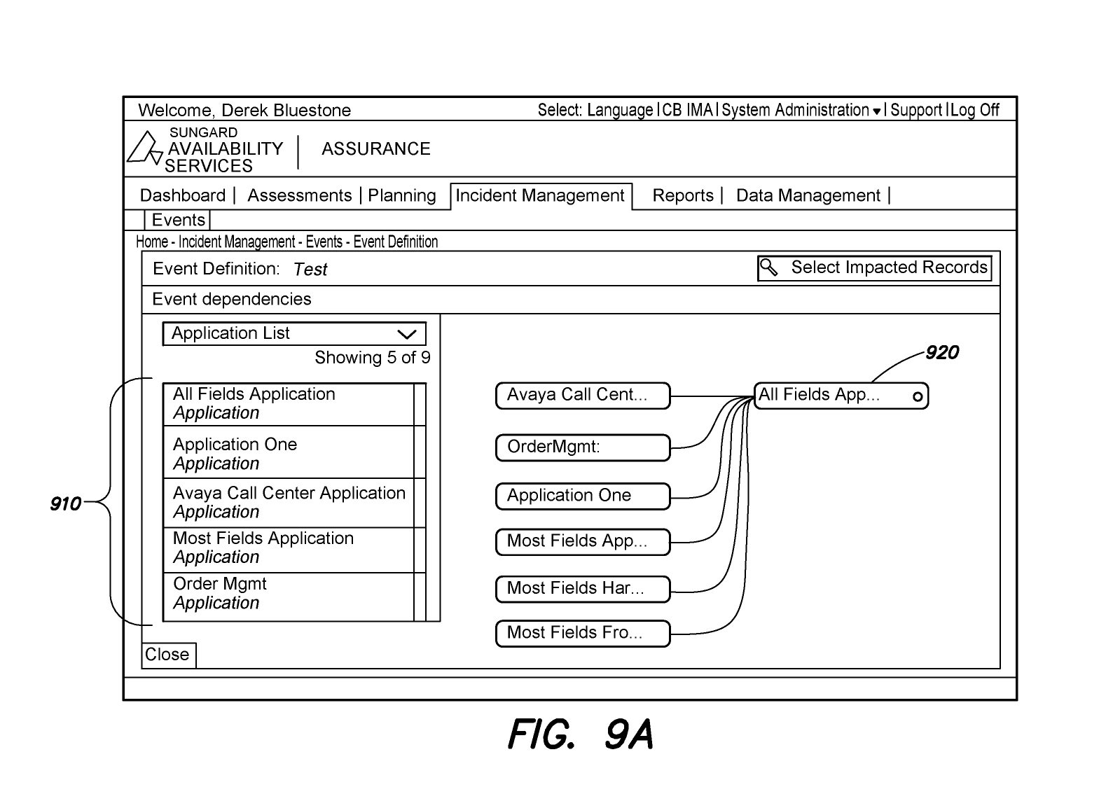

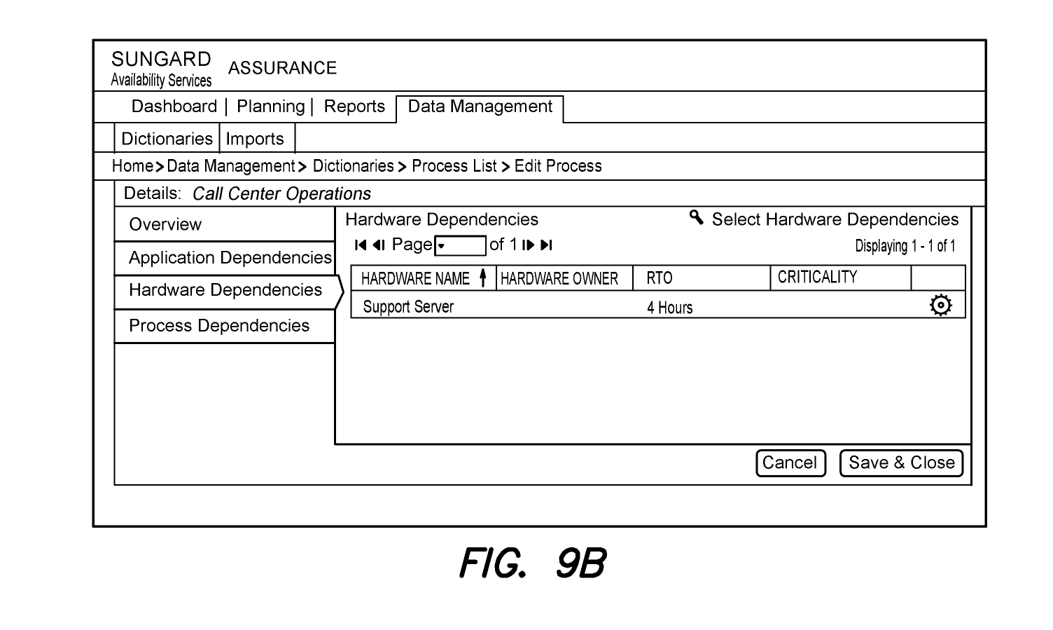

The user may further define event dependencies, via a screen such as FIG. 9A. Here the user may associate assets 910 that could possibly be impacted by the new event 920.

FIG. 9B is an example user interface screen for specifying dependencies between assets, procedures, tasks, or other objects. Here the user is specifying that the recovery process for a call center operation is dependent upon prior recovery of support server hardware. It should be understood that other types of dependencies, such as application or process (manual) may be specified for objects.

FIG. 10 is a further graphical user interface screen that the user selects via an incident management menu tab 890. Here the location 810 affected by the event (the Philadelphia headquarters) is again displayed. The user has selected which assets, applications, and business processes resident at the impacted location will actually be included in the recovery procedures. For example, the prior data dictionary definitions may indicate that a payroll application 812, and a function such as benefits administration 816 are in this location and critical. A Microsoft server 814 is also impacted. Also shown is a summary list of all possible impacted assets including all applications, hardware, locations, recovery plans, processes, and vendors associated with impacted location 810.

The need to recover processes to other locations away from the directly impacted location may result in a display of a GIS information area 840 with pin drops indicating the location of other assets needed to assume the affected location's functions. It should be understood that the affected assets 812, 814, 816 could be any set of assets, people, business processes etc., defined in the system that have had some of relationship to the affected location 810, defined as a result of the user previously defining the relationships of these assets to the location 810. This information could have originated from the CMDB, automated propagation functions, may have been provided from other facilities or other systems, or via manual input.

As explained below, in this example, recovery of certain assets such as the payroll function will be instantiated via a set of automated tasks and procedures such as recovery of a Microsoft server that runs an SAP payroll application.

Other business processes such as a benefits administration department 816 may require manual procedures to be carried out such as notifying a backup facilities location elsewhere in the city, turning on HVAC systems, and unlocking doors. It is also possible that benefits department 816 has only recently moved to the headquarters location on Broad Street and the user had not previously indicated a particular sequence of steps to recover this business process. However, some other administrator may have at least indicated to Plan Visualization that the benefits administration function had moved to headquarters. This business process information will at least appear in this via because it has been related in a relational database 200. Thus it does not matter if a particular, single, event planner has defined all possible assets that may be affected by an event as long as the assets and functions are reported to the relational database system at least in part.

FIG. 11 is a further screen presented to the user by selecting the incident management tab 890, showing the status of recovery plans that have been activated. A Recovery Status area 1111 is a flow diagram where the nodes (or “bubbles”) may indicate a specific task/subtask and may be colored green, yellow, or red based upon whether or not the given task is complete, in process, or not yet started. The branches (“arrows”) indicate dependencies between tasks. On the left-hand side is a list 1100 of recovery tasks, on the lower right hand side 1130 is a GANTT chart type display showing detailed progress of each task. As shown the recovery list 1100 includes execution of a Crisis Management Plan 1120 for the selected location 1121, an automated recovery process 1122 for the Microsoft server, automated recovery process 1124 for the SAP payroll application (running on the Microsoft server), a payroll business function 1126 restoration process, a SunGard Availability Services Plan 1128, and a Benefits Administration business process 1130. As can be seen, at the present time the Microsoft server 1122 has been recovered but the SAP payroll software 1124 is still in the process of being restored. The payroll business process has also been restored, but benefits administration has not yet begun recovery.

In the example herein, recovery of the Philadelphia headquarters requires bringing up certain affected business processes in a different physical location. The planner and/or administration does not know in advance which events will occur and which assets will be affected by the event. For example the event planner cannot foresee that a construction crane would fall in the street adjacent the Philadelphia headquarters, or that such an even would only impact certain headquarter functions and not others.

As a result of the crane falling event, only some of the functions in the headquarters building are considered critical enough to recover such as the SAP payroll application 1242, the payroll business process 1126 and benefits administration function 1130. These application processes and functions are going to be relocated to a different building in Philadelphia on Jasper Street. In this example the benefits administration function 1130 has only recently been moved to the Broad Street headquarters location thus at the time of recovery the disaster plan had no contingency for moving it from Broad Street. But the user via the screen in FIGS. 10 and 11 now realizes that they need to recover the benefits administration function as well because the relational database 200 had associated with it the location information for benefits administration being the Philadelphia headquarters.

The recovery flow and resulting view 1111 is generated algorithmically by Plan Visualization 100. This is done by searching to database 200 to find the tasks and procedures associated with the items in recovery list 1100. The system then can generate a critical path for the recovery tasks, and specifically determine which tasks can be executed in parallel or which must be executed in series to satisfy particular conditions. As explained previously, each task and/or subtask has associated with it one or more dependencies such that the task must be executed or satisfied prior to starting it. For example, the relational database 200 object representing the SAP payroll 1124 application indicates that is it is dependent upon prior recovery of the task that reinstantiates the Microsoft server hardware 1122 at the recovery location.

Thus it is understood how the system 100 may traverse all of the dependencies in the data dictionary for the included tasks to find a critical path therethrough, and generate the sequenced list of tasks and procedures to be executed. This sequenced list may include tasks that are automated recovery of assets (such as SAP payroll 1124, which may involve initiating an HP Orchestration engine for the recovered server) and may also include manual tasks (such as moving the benefits administration function 1130 which may include informing employees of the move, turning on the HVAC systems in the backup location and unlocking the doors at Jasper Street).

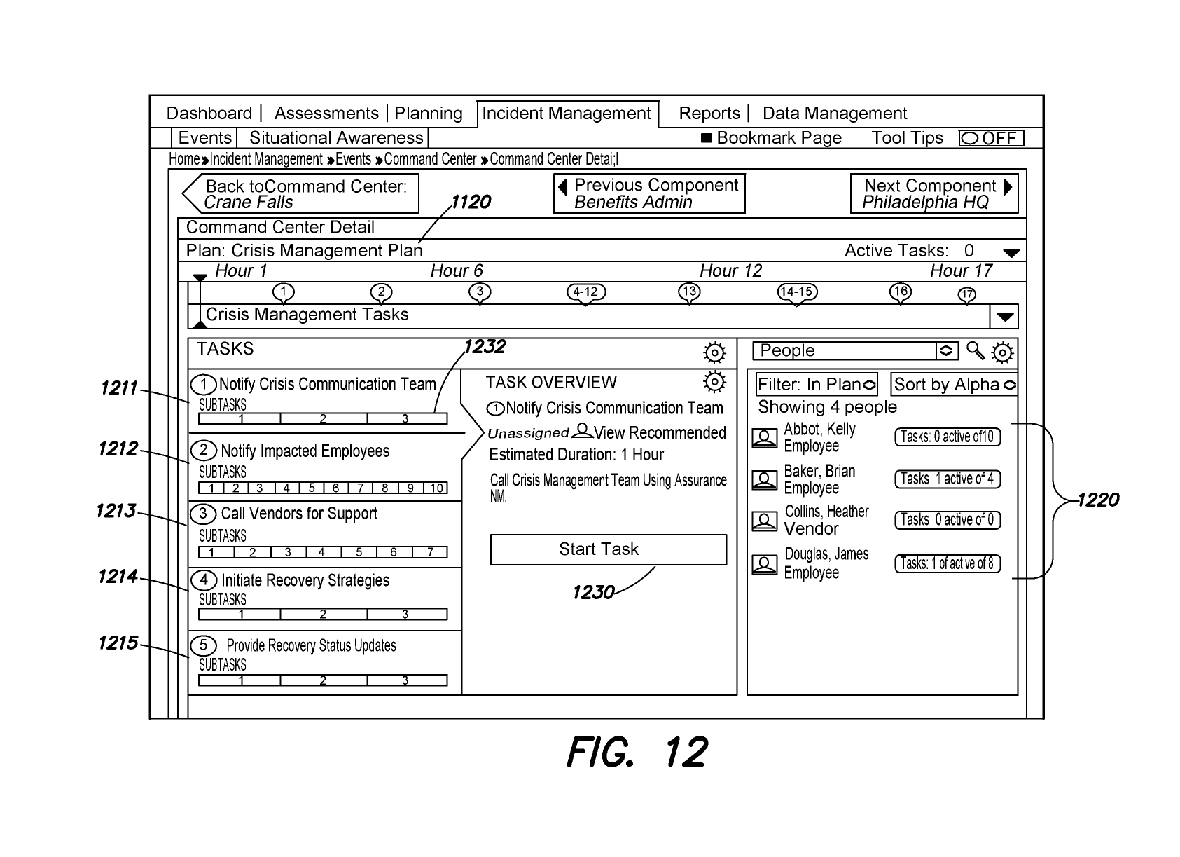

FIG. 12 is an example screen which may be shown to the user after they click on one particular item in the recovery list 1100. Here the user has clicked on the crisis management plan task 1120 which now allows them to view a detailed list of particular tasks that are to be carried out. Here the tasks include notifying the crisis communication team 1211, notifying impacted employees 1212, calling vendors 1213, initiating recovery strategies 1214, and providing recovery status updates 1215. The tasks may be displayed in further detail as represented by the numbered bars such as 1232. Here the user has asked for more detail on task 1211 (notify crisis communication team) to see an estimated duration and a description of the task. The subtasks may include notifying the four associated persons shown in the block 1220 to the right. At this point the user may indicate to the system they will start the selected task by clicking button 1230. This will cause the system to reflect the status of the task back to the command center and updating the recovery status flow diagram 1111. A timeline bar 1130 may also be cited to illustrate task progress.

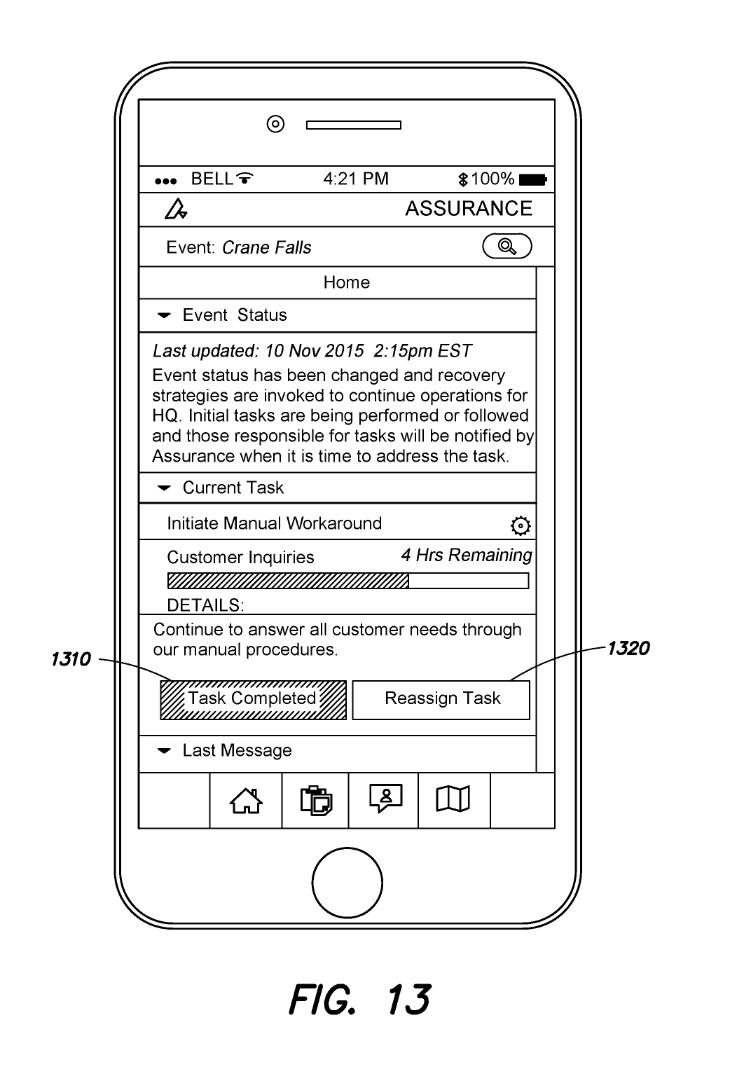

FIG. 13 is typical display that may be generated by a mobile application or web browser running on an incident responder's smartphone. The responder in question is Brian Baker, who is one of the responders on the Crisis Communications Team. Mr. Baker uses the display of FIG. 13 to view information specific to only his role in the overall recovery processing being carried out for the “Crane Falls: event. A particular subtask assigned to Mr. Baker includes “Initiating a manual workaround for customer inquiries”. It shows that he has four (4) hours remaining for this task. Also presented on his display are buttons including a task complete button 1310 and reassign task button 1320. By clicking this button 1310 when the manual workaround is completed, Mr. Baker can quickly report task status back to Plan Visualization 100. Plan Visualization can then update the recovery status views in FIG. 11 including the workflow view 1111 and the GANTT view 1130.

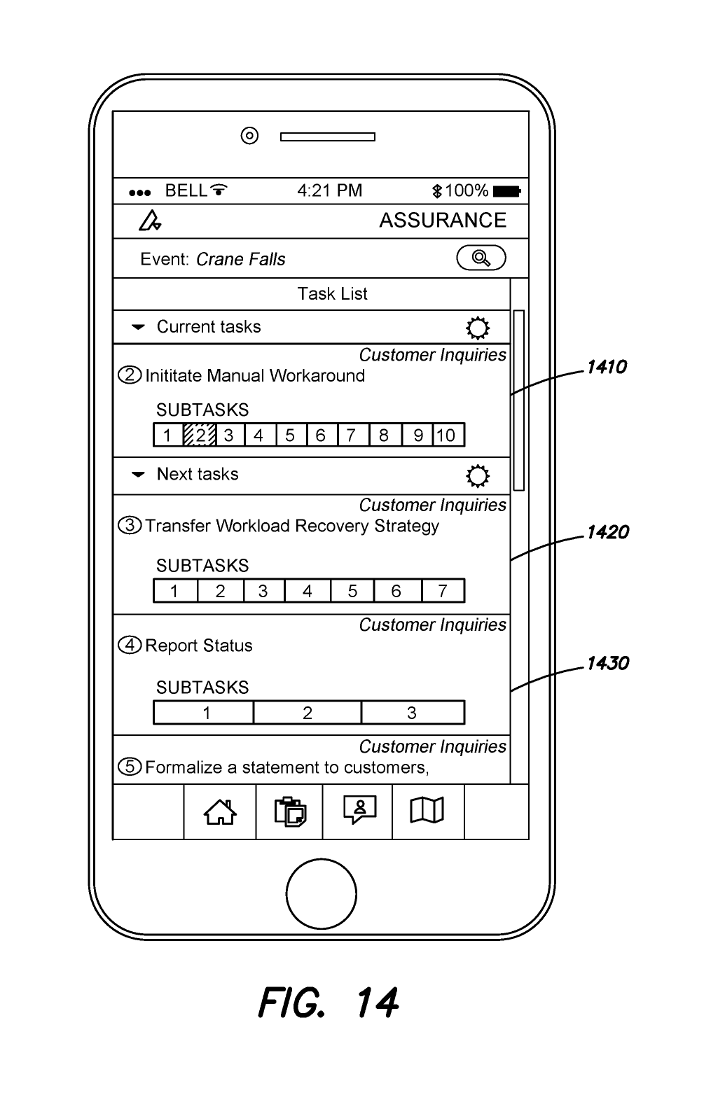

Mr. Baker can also select the view of FIG. 14 for a more detailed view of all of his tasks. It can be seen that he is working on “initiating a manual work around” 1410. In this view Mr. Baker can also see that he has several additional tasks including “Transferring workload recovery strategy” 1420, “Reporting status” 1430 and “Formalizing a statement to customers”. Each of these tasks for Mr. Baker may also include further subtasks for which he can obtain further instructions by clicking on the individual blocks in the horizontal bars.

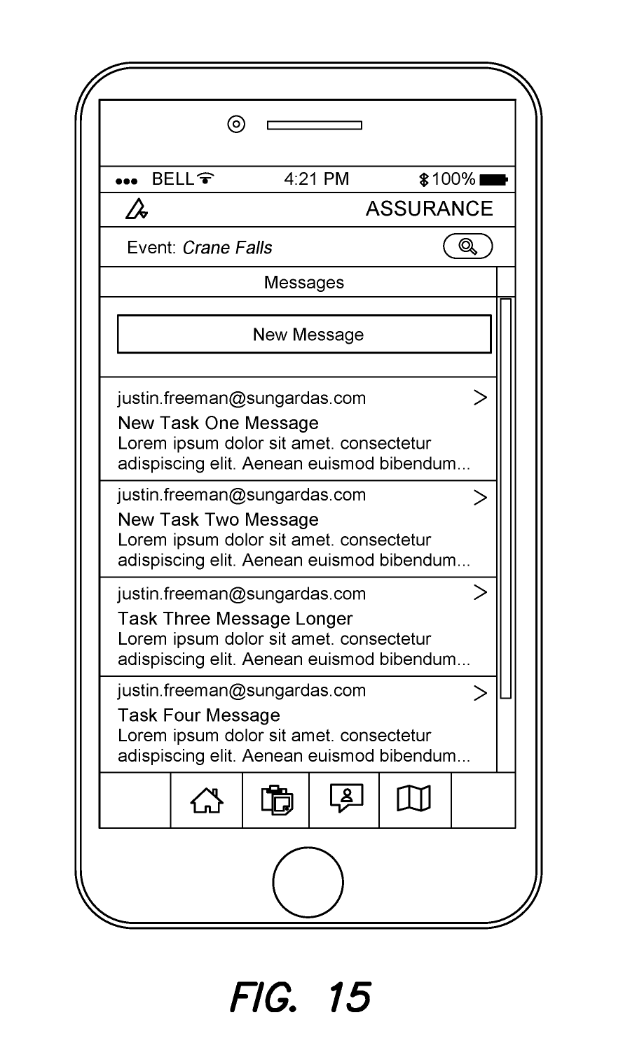

FIG. 15 is another screen that a responder may use to see incident specific messages. For example, instead of the user accessing their usual email application, Plan Visualization may divert crisis event messages to them via the recovery smartphone application. Here, responder Justin Freeman has two messages relating to “new task one” and ‘new test two” to which he has not yet responded. FIG. 16 is a representative event map that a responder may see on their phone for the incident. Pin drops in particular may visually indicate the physical locations impacted by the event. The impacted location may not only be Headquarters on Broad Street 1630 that suffered actual physical damage, but may also include recovery locations such as the Jasper Street location 1620 that is hosting backup assets. Also, clicking on a pin may bring up further information such as the status of recovery events at that location relevant to the specific event responder.

FIG. 17 is a screen that may be seen by administrative users via a computer. Here the impacted locations are also shown with pin drops, this view also supports overlays. Such overlays may be important to see for certain types of disasters, and may include this disaster alert, newsfeeds, weather bulletins, live earthquake maps or other GIS information that can be integrated with system.

### Summary and Conclusion

Automated steps executed by the Plan Visualization system 100 that effect change in other computer devices and systems include

Step 1: Create an event in the system that describes the disaster (ex. Hurricane, Flood, Active Shooter, Power Failure). This is an end user generated, manual step within the system.

Step 2. Specify the Plan(s) that need to be activated as well as any ancillary information necessary to invoke the Plan (ex. Locations, Business Processes). This is an end user generated, manual step within the system.

Step 3: The system then automatically invokes the following actions which effect change in other computers and systems
a. Automatic, dynamic generation of a technical runbook which specifies the exact configuration of systems (software, hardware, network, memory, storage, virtual machines etc.) that need to be instantiated in a remote public or private cloud environment (ex. Google Cloud, Amazon Web Services or Microsoft Cloud)
b. Communicating this runbook, via the Internet, to the remote public or private cloud provider using said cloud providers Web Services—and automatically provisioning the exact software, hardware, network, memory, storage in the form of virtual machines specified in the runbook
c. Once the public or private cloud environment is completely set up, dynamically trigger the restoration of application software data into the system (for example: all Human Resources data into Oracle's Peoplesoft application)
d. Once complete, automatic targeted message alerts in the form of SMS, e-mail, push messaging, Text to Speech to be delivered to other computers and smartphones indicating that manual testing of the environment needs to begin.
   The technical effects described above also serve two new purposes, causing the computer systems to operate differently than in prior art systems, at least as follows:

a) to turn the computer(s) into an intelligent provisioning system for technical resources in a geographically distinct locale. For example, the system can now automatically provision net new computing environments in adequate size and configuration in order to affect recovery from a disaster, including automated and manual processes;

b) to turn the computer into an intelligent mass communication vehicle, distributing tasks and assignments automatically to other computers and smartphones with the appropriate tasks and recovery procedures necessary to recovery from a disaster; and

c) to become an intelligent “command center” which can receive status updates, initiate follow up communications, and assign new tasks and procedures.

The approach improves over known recovery procedures by introducing parallel, procedural assignments to other computers under disaster recovery circumstances—when performance and speed are paramount to life safety and risk reduction.

Initiating and properly executing a Disaster Recovery Plan is a complex, sometimes life and safety threatening endeavor. The invention(s) described herein overcome the very problem of coordination, assignment of recovery procedures, intelligent provisioning of equivalent technology environments, restoration of applications on these newly provisioned technology environments and intelligent, mass communication to other computers and smartphones.

Previously, manual, inadequate methods were employed—always riddled with errata and latency thereby increasing risk to human safety, financial and reputational loss.

What is claimed is:

1. A method for triggering a set of processes to recover a protected location after a disaster event comprising:
prior to the disaster event, operating a database management system for:
storing an event object that describes the disaster event and at least one metadata attribute of the event object;
storing one or more affected assets objects that describe assets that are impacted by the disaster event, the affected assets including one or more location, business process, or data processing application;
storing one or more plan objects related to the affected asset objects, the plan objects specifying at least one manual task and at least one automated procedure to recover the affected asset objects as a result of an occurrence of the disaster event;
after the disaster event, operating a data processor for:
programmatically assembling a sequenced set of recovery procedures and tasks based on the event object and affected assets object including an impacted location, business process or data processing application;
programmatically assigning manual tasks to respective responder personnel and assigning procedures to automated recovery processes;
forwarding information to personal devices associated with responder personnel describing the assigned manual tasks;
initiating automated recovery of the data processing application by an external automated recovery system;
receiving information concerning completion status of manual tasks from the personal devices and from the procedures executed by the automated recovery system;
displaying completion status information for the manual tasks and automated procedures.

2. The method of claim 1 wherein the metadata attribute indicates a dependency of a particular task on an other task such that the particular task cannot be initiated until the other task is completed.

3. The method of claim 1 wherein the affected assets include one or more physical locations, personnel, data processing applications, or business processes.

4. The method of claim 1 wherein the completion status information is presented as a single dynamic flow diagram indicating both the algorithmically determined critical path for and the status of completion of both manual tasks and automated recovery procedures.

5. The method of claim 1 wherein the automated recovery process recovers applications and/or hardware assets to a computing cloud.

6. The method of claim 5 wherein the automated recovery process further comprises an orchestration engine.

7. The method of claim 1 wherein the information sent to responder personnel is specific to the particular responding individual.

8. The method of claim 7 wherein the information is forwarded to the responder personnel based on a defined communication preference including one or more of a Short Message Service (SM), e-mail, push message service, or Text to Speech delivered to a personal computer or smartphone associated with the responder.

9. The method of claim 1 wherein the information is a description of a particular task forwarded to a smartphone application, and the smartphone application presents a user interface screen with the task description and a status update button, and the smartphone application further operating such that when the status update button is selected, the smartphone application sends a message to the data processing system indicating completion of the particular task.

10. The method of claim 1 wherein the data processing system further displays Geographic Information System (GIS) information relevant to the recovery, including at least a map with a visual indication of an impacted resources including the location of one or more buildings, business processes, people, vendors, or customers.
